(19) United States
(12) Patent Application Publication
(10) Pub. No.: US 2010/0177024 A1
(43) Pub. Date: Jul. 15, 2010

(54) Organic light emitting display

(76) Inventor: Sang-Moo Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/588,315

(22) Filed: Oct. 13, 2009

(30) Foreign Application Priority Data
Jan. 12, 2009 (KR) 10-2009-0002231

(51) Int. Cl. G09G 3/30

(52) U.S. Cl. 345/76

(57) ABSTRACT

An organic light emitting display, includes scan lines and data lines that overlap each other, a pixel unit including pixels positioned at intersections of the scan lines and the data lines, a main power source line at one end of the pixel unit and adapted to receive a voltage of a first power source, and sub power source lines coupled to the main power source line and the pixels, wherein each of the pixels comprises at least one capacitor, and the capacitors have different capacitances based on a position of the respective pixels relative to the main power source line.

### BACKGROUND

1. Field

Embodiments relate to an organic light emitting display, and more particularly, to an organic light emitting display capable of displaying an image with uniform brightness.

2. Description of Related Art

Recently, various flat panel displays (FPD) having relatively less weight and volume than cathode ray tubes (CRT) have been developed. Such FPDs include liquid crystal displays (LCDs), field emission displays (FEDs), plasma display panels (PDPs), and organic light emitting displays.

Among the FPDs, organic light emitting displays display images using organic light emitting diodes (OLED) that generate light by re-combination of electrons and holes. Organic light emitting displays have relatively high response speed and consume relatively low power.

Pixels of an organic light emitting display may each include an OLED and a pixel circuit for driving the OLED. The OLED of a pixel being driven may generate light with predetermined brightness corresponding to current supplied from the pixel circuit, and more particularly, corresponding to an amount of current supplied from a driving transistor of the pixel circuit.

The organic light emitting display may include a panel including a main power source line on one side of the panel and a plurality of sub power source lines extending parallel to data lines of the display. The sub power source lines may supply the first power source to the pixels. A voltage value of the first power source supplied to the pixels varies based on a position of the pixel. That is, since the first power source is supplied via the sub power source lines, a predetermined IR drop is generated and a voltage of the first power source received by the pixels further from the main power source line may be lower than a voltage of the first power source received by pixels relatively closer to the main power source.

As a voltage of the first power source varies based on positions of the pixel, a non-uniform image may be displayed. Actually, when a same data signal is supplied to the pixels, brightness may be reduced from a side of the panel where the main power source line is positioned to an opposite side of the panel.

### SUMMARY

Embodiments are therefore directed to an organic light emitting display, which overcomes one or more of the problems due to the limitations and disadvantages of the related art.

It is therefore a feature of an embodiment to provide an organic light emitting display capable of displaying an image with improved and/or substantially and/or completely uniform brightness.

It is therefore a feature of an embodiment to provide an organic light emitting display in which a capacitance of capacitors included in each of the pixels is controlled to compensate for an IR drop of the first power source.

It is therefore a feature of an embodiment to provide an organic light emitting display adapted to display an image with improved and/or substantially and/or completely uniform brightness regardless of the IR drop of the first power source.

At least one of the above and other features may be realized by providing organic light emitting display, including scan lines and data lines that overlap each other, a pixel unit including pixels positioned at intersections of the scan lines and the data lines, a main power source line at one end of the pixel unit and adapted to receive a voltage of a first power source, and sub power source lines coupled to the main power source line and the pixels, wherein each of the pixels comprises at least one capacitor, and the capacitors have different capacitances based on a position of the respective pixels relative to the main power source line.

The capacitances of the capacitors may vary in groups of one or more rows of pixels, the rows of the pixels may extend along a direction parallel to a direction along which the main power source line extends.

The capacitances of the capacitors may vary in groups of one or two rows of pixels, the rows of the pixels may extend along a direction parallel to a direction along which the main power source line extends.

Each of the pixels may include an organic light emitting diode, a driving transistor adapted to control an amount of current that flows from the first power source to a second power source via the organic light emitting diode, a storage capacitor coupled between a gate electrode of the driving transistor and the first power source, and a driver coupled to the respective data line and the respective scan line to supply a data signal supplied from the respective data line to the storage capacitor based on a scan signal supplied to the respective scan line.

The further the respective pixel is from the main power source line, the greater the capacitance of the storage capacitor of the respective pixel may be.

Each of the pixels may include an organic light emitting diode, a driving transistor adapted to control an amount of current that flows from the first power source to a second power source via the organic light emitting diode, a threshold capacitor and a storage capacitor serially coupled between a gate electrode of the driving transistor and the first power source, and a driver coupled to the respective data line and the respective scan lines to supply a data signal supplied from the respective data line to the storage capacitor based on a scan signal supplied to the respective scan line.

Each of the pixels may include an organic light emitting diode, a driving transistor adapted to control an amount of current that flows from the first power source to a second power source via the organic light emitting diode, a storage capacitor coupled between a gate electrode of the driving transistor and the first power source, a second transistor coupled between the respective data line and the gate electrode of the driving transistor to be controlled by a scan signal supplied to the respective scan line, a third transistor coupled between the driving transistor and the organic light emitting diode and adapted to be controlled by an emission control signal supplied from an emission control line extending parallel with the scan lines, and a boosting capacitor coupled between the gate electrode of the driving transistor and one of the respective scan line or the respective emission control line.

When the boosting capacitor is coupled between the gate electrode of the driving transistor and the respective scan line and the further the respective pixel is from the main power source line, the smaller the capacitance of the boosting capacitor of the respective pixel may be.

When the boosting capacitor is coupled between the gate electrode of the driving transistor and the respective emission control line and the further the respective pixel is from the main power source line, the greater the capacitance of the boosting capacitor of the respective pixel may be.

The sub power source lines may extend parallel to the data lines.

The display may include a second main power source line arranged an another end of the pixel unit to receive the voltage of the first power source, wherein the capacitors have different capacitances based on a position of the respective pixels relative to the main power source line or the second main power source line to which it is connected.

At least one of the above and other features and advantages may be realized by providing an organic light emitting display, including scan lines and data lines that overlap each other, a pixel unit including pixels positioned at intersections of the scan lines and the data lines and each having at least one capacitor, a main power source line arranged at one end of the pixel unit to receive a voltage of a first power source, and sub power source lines extending from the main power source line and coupled to the pixels in units of vertical lines, wherein the pixel unit is divided into a plurality of blocks each including at least two rows of the pixels, and main power source voltage compensating unit adapted to compensate for an voltage drop of the voltage of the first power source supplied to each of the pixels via the subs power source lines.

At least one of the above and other features and advantages may be realized by providing an organic light emitting display, including scan lines and data lines that overlap each other, a pixel unit including pixels positioned at intersections of the scan lines and the data lines and each having at least one capacitor, a main power source line arranged at one end of the pixel unit to receive a voltage of a first power source, and sub power source lines extending from the main power source line and coupled to the pixels in units of vertical lines, wherein the pixel unit is divided into a plurality of blocks each including at least two rows of the pixels, and the capacitors of the pixels of each of the blocks have different capacitances based on a position of the respective block with which the respective pixel is associated with relative to the main power source line.

Each of the pixels may include an organic light emitting diode, a driving transistor adapted to control an amount of current that flows from the first power source to a second power source via the organic light emitting diode, a storage capacitor coupled between a gate electrode of the driving transistor and the first power source, and a driver coupled to the respective data line and the respective scan line to supply a data signal supplied from the respective data line to the storage capacitor based on a scan signal supplied to the respective scan line.

The further the respective bock is from the main power source line, the greater the capacitance of the storage capacitors of the respective block may be.

Each of the pixels may include an organic light emitting diode, a driving transistor adapted to control an amount of current that flows from the first power source to a second power source via the organic light emitting diode, a threshold capacitor and a storage capacitor serially coupled between a gate electrode of the driving transistor and the first power source, and a driver coupled to the respective data line and the respective scan line to supply a data signal supplied from the respective data line to the storage capacitor to correspond to a scan signal supplied to the respective scan line.

Each of the pixels may include an organic light emitting diode, a driving transistor to control an amount of current that flows from the first power source to a second power source via the organic light emitting diode, a storage capacitor coupled between a gate electrode of the driving transistor and the first power source, a second transistor coupled between the data lines and the gate electrode of the driving transistor to be controlled by a scan signal supplied to the scan lines, third transistor coupled between the driving transistor and the organic light emitting diode and adapted to be controlled by an emission control signal supplied from an emission control line formed parallel with the scan lines, and a boosting capacitor coupled between the gate electrode of the driving transistor and the respective scan line or the respective emission control line.

The boosting capacitor of each of the pixels may be coupled between the gate electrode of the driving transistor and the respective scan line and the further the respective bock is from the main power source line, the less the capacitance of the boosting capacitors of the respective block may be.

The boosting capacitor of each of the pixels may be coupled between the gate electrode of the driving transistor and the respective emission control line and the further the respective bock is from the main power source line, the greater the capacitance of the boosting capacitors of the respective block may be.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an exemplary embodiment of an organic light emitting display;

FIG. 2 illustrates a circuit diagram of an exemplary embodiment of a pixel employable in the organic light emitting display of FIG. 1;

FIG. 3 illustrates a circuit diagram of an exemplary embodiment of the driver of FIG. 2;

FIG. 4 illustrates a circuit diagram of another exemplary embodiment of a pixel employable in the organic light emitting display of FIG. 1;

FIG. 5 illustrates a circuit diagram of an exemplary embodiment of the driver of FIG. 4;

FIG. 6 illustrates a circuit diagram of another exemplary embodiment of a pixel employable in the organic light emitting display of FIG. 1;

FIG. 7 illustrates a circuit diagram of another exemplary embodiment of a pixel employable in the organic light emitting display of FIG. 1;

FIG. 8 illustrates a block diagram of another exemplary embodiment of an organic light emitting display; and

FIG. 9 illustrates a simulation result graph of a relationship between capacity and brightness of a capacitor.

### DETAILED DESCRIPTION OF EXEMPLARY EMBODIMENTS

Korean Patent Application No. 10-2009-0002231, filed on Jan. 12, 2009, in the Korean Intellectual Property Office, and entitled: “Organic Light Emitting Display,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will be understood that when an element is referred to as being “between” two elements, it can be the only element between the two layers, or one or more intervening elements may also be present. Like reference numerals refer to like elements throughout the specification.

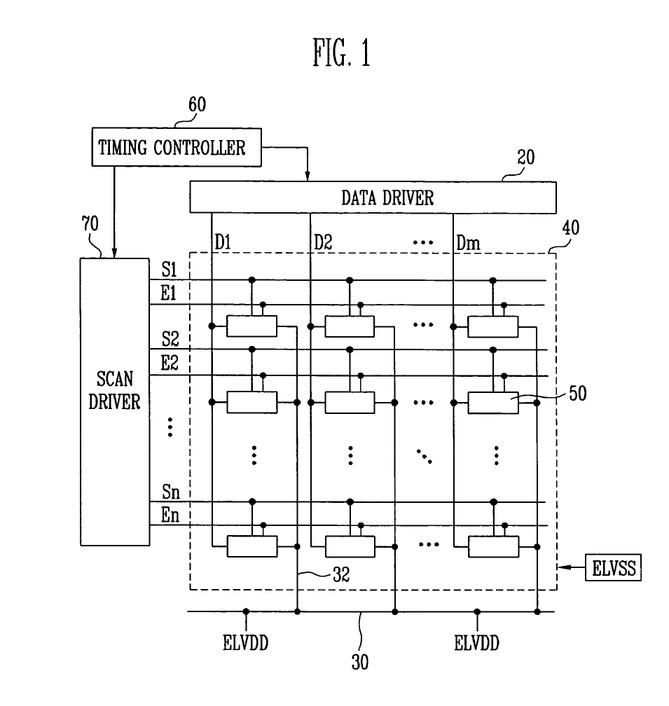

Hereinafter, exemplary embodiments by which those skilled in the art may easily embody one or more features described herein will be described in detail with reference to the accompanying FIGS. 1 to 9.

FIG. 1 illustrates a block diagram of an exemplary embodiment of an organic light emitting display.

Referring to FIG. 1, the exemplary organic light emitting display may include a data driver 20, a pixel unit 40, a timing controller 60 and a scan driver 70. The pixel unit 40 may include a plurality of pixels 50 coupled to scan lines S1 to Sn, data lines D1 to Dm, and emission control lines E1 to En. The scan driver 70 may drive the scan lines S1 to Sn and the emission control lines E1 to En. The data driver 20 may drive the data lines D1 to Dm. The timing controller 60 may control the scan driver 70 and the data driver 20.

Referring to FIG. 1, the exemplary organic light emitting display may include a main power source line 30 and sub power source lines 32. The main power source line 30 may be positioned at one end of the pixel unit 40. The sub power source lines 32 may be coupled to the main power source line 30. The sub power source lines 32 may extend parallel to the data lines D1 to Dm and be coupled to the pixels 50.

The scan driver 70 may be controlled by the timing controller 60 to sequentially supply scan signals to the scan lines S1 to Sn. The scan driver 70 may also be controlled by the timing controller 60 to sequentially supply emission control signals to the emission control lines E1 to En. In the exemplary embodiment, the emission control signal supplied to the ith (i is a natural number) emission control line Ei is supplied to overlap the scan signal supplied to the ith scan line Si. It should be understood, e.g., that while the emission control lines E1 to En are illustrated for convenience in FIG. 1, the emission control lines E1 to En may be left out of an illustration of a structure of the pixel 50.

When the scan signals are sequentially supplied to the scan lines S1 to Sn, the pixels 50 may be sequentially selected in units of horizontal lines. When the emission control signals are sequentially supplied to the emission control lines E1 to En, the pixels 50 selected by the scan signals may be in a non-emission state. That is, the emission control signals may prevent the pixels 50 selected by the scan signals from generating unnecessary light during a period when voltages corresponding to data signals are charged.

The data driver 20 may be controlled by the timing controller 60 to supply the data signals to the data lines D1 to Dm. The data driver 20 may supply the data signals to the data lines D1 to Dm when the scan signals are supplied. The data signals may be supplied to the pixels 50 selected by the scan signals and the pixels 50 may charge voltages corresponding to the data signals supplied thereto.

The main power source line 30 may be positioned at one end of the pixel unit 40. The main power source line 30 may receive a voltage of an external first power source ELVDD.

The sub power source lines 32 may be formed to extend in a direction crossing a direction along which the scan lines S1 to Sn extend. The sub power source lines 32 may supply a voltage of the first power source ELVDD supplied from the main power source line 30 to the pixels 50. Therefore, the sub power source lines 32 may be arranged in vertical lines and may be coupled to the pixels 50.

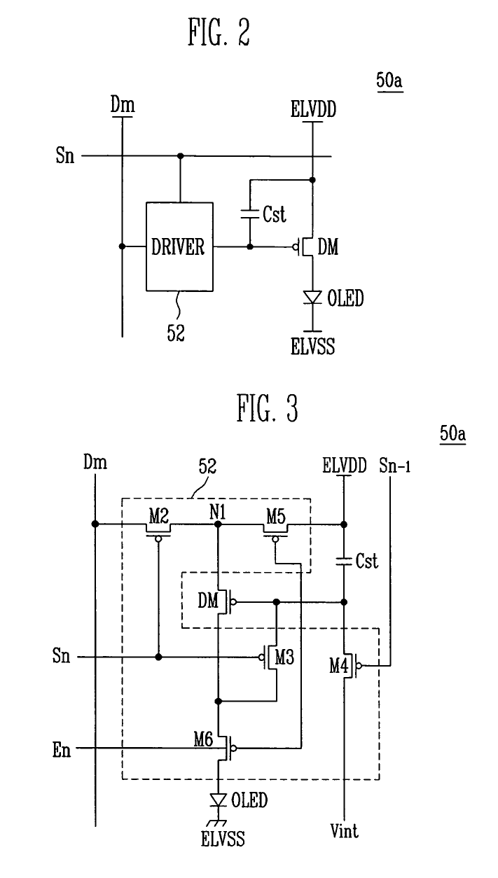

The pixel unit 40 may include the plurality of pixels 50 positioned at intersections of the scan lines S1 to Sn and the data lines D1 to Dm. The pixels 50 may receive the data signals when the scan signals are supplied. Each of the pixels 50 may include an organic light emitting diode OLED (see, e.g., FIG. 2) and may supply a current corresponding to the received data signal from the first power source ELVDD to a second power source ELVSS via the organic light emitting diode OLED thereof. Accordingly, the organic light emitting display may display an image with predetermined brightness.

Each of the pixels 50 may include at least one capacitor. A capacitance of the capacitor included in each of the pixels 50 may be set to vary based on a position of the respective pixel 50 relative to the main power source line 30. For example, in the exemplary embodiment of FIG. 3, a capacitance of the pixels 50 in an nth horizontal row associated with the nth emission control line En and the nth scan line Sn may be less than a capacitance of the pixels 50 in a 2^{nd} horizontal row associated with the 2^{nd} emission control line E2 and the 2^{nd} scan line S2. More particularly, e.g., a capacitance of the capacitor respectively included in each of the pixels 50 may be set so that the IR drop of the first power source ELVDD voltage supplied from the main power source line 30 to the sub power source lines 32 may be substantially and/or completely compensated.

Referring to FIG. 1, in the exemplary embodiment of the display illustrated therein, the main power source line 30 is arranged at one end of the pixel unit 40. However, embodiments are not limited thereto. For example, in some embodiments, the main power source line 30 may be arranged at two ends of the pixel unit 40. In such cases, e.g., in which the main power source line 30 is formed at multiple, e.g., two, ends of the pixel unit 40, the capacitance of the respective capacitor included in each of the pixels 50 may be set so that the IR drop of the first power source ELVDD voltage may be substantially and/or completely compensated for.

FIG. 2 illustrates a circuit diagram of an exemplary embodiment of a pixel 50a employable in the organic light emitting display of FIG. 1.

Referring to FIG. 2, the pixel 50a may include an organic light emitting diode OLED, a driving transistor DM to supply current to the OLED, a driver 52 to transmit a data signal to the driving transistor DM, and a capacitor Cst to be charged with the voltage corresponding to the data signal.

The OLED may generate light with predetermined brightness based on a current supplied from the driving transistor DM. Actually, the OLED may generate light having one color among red, green, and blue based on the current supplied from the driving transistor DM.

The storage capacitor Cst may be coupled between a gate electrode of the driving transistor DM and a first power source ELVDD. The storage capacitor Cst may maintain a predetermined voltage supplied from the driver 52 for one frame. Capacitance of the capacitor Cst may be set based on a position at which the respective pixel 50a is provided.

For example, the further the respective pixel 50a is from the main power source line 30, the greater the capacitance of the storage capacitor Cst included in the respective pixel 50a may be. That is, capacitances of the storage capacitors Cst of the respective pixels 50a may increase from one end of the pixel unit 40 at which the main power source line 30 is formed toward another end of the pixel unit 40 that faces the one end.

As the capacitance of the storage capacitor Cst increases, a speed at which a voltage is charged in the storage capacitor Cst is generally reduced. More particularly, e.g., in general, as a voltage of a capacitor increases, the increasing voltage may oppose a flow of more charge and a flow of current may decrease, i.e., a rate at which a capacitor charges may decrease as more and more charge builds up in a capacitor. Thus, referring to FIG. 2, as the capacitance of the storage capacitor Cst is increased, a speed at which voltage is charged in the storage capacitor Cst may be reduced.

Referring to FIG. 2, when the voltage stored in the storage capacitor Cst arranged between the gate electrode of the driving transistor and the first power source ELVDD is reduced, the amount of current supplied from the driving transistor DM, e.g., a p-type transistor, to the OLED may increase and brightness may increase. Therefore, in embodiments, the further the pixel 50a is from the main power source line 30, the capacitance of the storage capacitor Cst may be higher, and the IR drop of the first power source ELVDD voltage may be substantially and/or completely compensated. Thus, embodiments may enable an image with improved and/or substantially/completely uniform brightness to be displayed regardless of the IR drop of the first power source ELVDD voltage.

The driving transistor DM may supply current corresponding to the voltage stored in the storage capacitor Cst to the OLED.

The driver 52 may receive the data signal from the data line Dm when a scan signal is supplied to the scan line Sn and may supply the received data signal to the storage capacitor Cst. Here, the driver 52 may additionally supply the voltage corresponding to the threshold voltage of the driving transistor DM to the storage capacitor Cst.

It should be understood that the driver 52 may be realized by various circuits. For example, in some embodiments, the driver 52 may simply be a switch, e.g., a transistor.

FIG. 3 illustrates a circuit diagram of an exemplary embodiment of the driver 52 of FIG. 2.

Referring to FIG. 3, in some embodiments, the driver 52 may be adapted such that a threshold voltage of the driving transistor DM may be additionally charged in the storage capacitor Cst. An operation of the exemplary driver 52 of FIG. 3 will be described below. First, a fourth transistor M4 may be turned on so that a gate electrode of the driving transistor DM may be initialized by a voltage of an initialization power source Vint. Then, second and third transistors M2 and M3 may be turned on so that the data signal may be supplied to the gate electrode of the driving transistor DM. Here, since the data signal is supplied via the driving transistor DM that is in a diode-connected state, the data signal and the voltage corresponding to the threshold voltage of the driving transistor DM may be additionally charged in the storage capacitor Cst.

Then, a fifth transistor M5 and a sixth transistor M6 may be turned on. When the fifth transistor M5 and the sixth transistor M6 are turned on, the current corresponding to the voltage charged in the storage capacitor Cst by the driving transistor DM may be supplied to the OLED.

It should be understood that embodiments are not limited to the exemplary embodiment illustrated in FIGS. 2 and 3. For example, in embodiments, the pixel 50 of an organic light emitting display may be different than the pixel 50a of FIGS. 2 and 3. In general, the pixels 50 may each include the storage capacitor Cst to be charged with the voltage of the respective data signal.

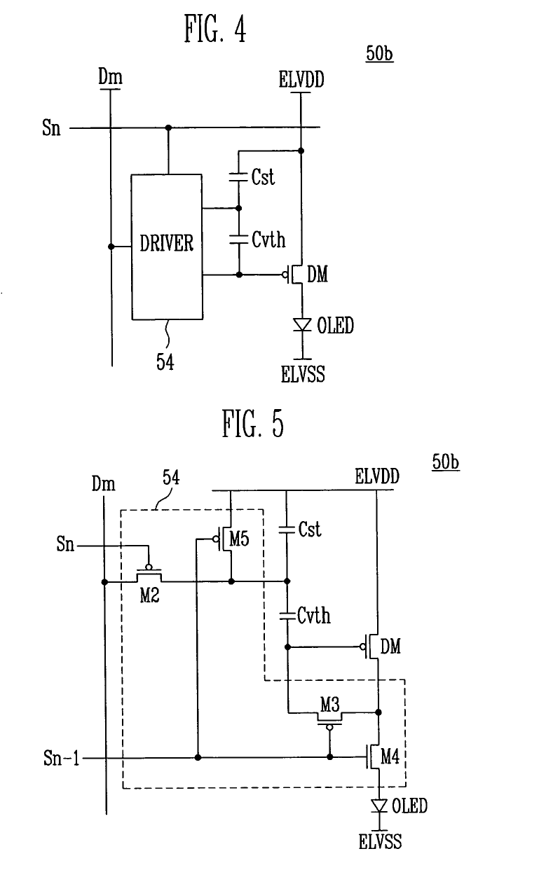

FIG. 4 illustrates a circuit diagram of another exemplary embodiment of a pixel 50b employable in the organic light emitting display of FIG. 1.

Referring to FIG. 4, the pixel 50b may include an OLED, a driving transistor.

DM to supply current to the OLED, a driver 54 to control a voltage supplied to the driving transistor DM, a storage capacitor Cst to be charged with a voltage corresponding to a data signal, and a threshold capacitor Cvth to be charged with a voltage corresponding to the threshold voltage of the driving transistor DM.

The OLED may generate light with predetermined brightness based on the current supplied from the driving transistor DM. Actually, the OLED may generate light having one color among red, green, and blue based on the current supplied from the driving transistor DM.

Referring to FIG. 4, the threshold capacitor Cvth and the storage capacitor Cst may be coupled in series between a gate electrode of the driving transistor DM and a first power source ELVDD.

The storage capacitor Cst may charge the voltage corresponding to the data signal and maintain the charged voltage for one frame.

The threshold capacitor Cvth may charge the voltage corresponding to the threshold voltage of the driving transistor DM and maintain the charged voltage for one frame. The capacitance of the threshold capacitor Cvth may be set based on a position at which the respective pixel 50b is provided.

For example, the further the pixel 50b is from the main power source line 30, the threshold capacitor Cvth included in the pixel 50b may have a higher capacitance. That is, the capacitances of the threshold capacitors Cvth may increase from one end of the pixel unit 40 where the main power source line 30 is arranged toward another end, e.g., an end opposite to the end where the main power source line 30 is arranged.

As the capacitance of the threshold capacitor Cvth increases, a speed at which the voltage charged in the threshold capacitor Cvth may be reduced so that a voltage finally stored in the threshold capacitor Cvth may be reduced. When the voltage stored in the threshold capacitor Cvth is reduced, an amount of current supplied from the driving transistor DM to the OLED may increase so that brightness of the pixel 50b may increase. Therefore, in embodiments, the further the pixel 50b is from the main power source line 30, the greater the capacitance of the respective threshold capacitor Cvth may be, and the IR drop of the first power source ELVDD may be substantially and/or completely compensated. Thus, e.g., embodiments may enable an image with improved and/or uniform/substantially uniform brightness may be displayed regardless of the IR drop of the first power source ELVDD. As described above, the present invention can be applied to various pixels 50 including the threshold capacitor Cvth to be charged with the threshold voltage of the driving transistor DM.

The driving transistor DM may supply the current corresponding to the voltages stored in the storage capacitor Cst and the threshold capacitor Cvth to the OLED.

The driver 54 may receive the data signal from the data line Dm when a scan signal is supplied to the scan line Sn and may supply the received data signal to the storage capacitor Cst. In addition, the driver 54 may charge the voltage corresponding to the threshold voltage of the driving transistor DM in the threshold capacitor Cvth.

The driver 54 may be realized by various circuit configurations/elements that may drive the storage capacitor Cst and the threshold capacitor Cvth. For example, the driver 54 may include four transistors M2, M3, M4 and M5, as illustrated in FIG. 5. FIG. 5 illustrates a circuit diagram of an exemplary embodiment of the driver 54 of FIG. 4.

General operation of the driver 54 will be described. A fourth transistor M4 may be turned off and a fifth transistor M5 may be turned on by an n−1th scan signal supplied to an (n−1)th scan line Sn−1. When the fourth transistor M4 is turned off and the fifth transistor M5 is turned on, a voltage corresponding to the threshold voltage of the driving transistor DM may be charged to the threshold capacitor Cvth.

Then, a second transistor M2 may be turned on by the scan signal supplied to the scan line Sn. When the second transistor M2 is turned on, the voltage corresponding to the respective data signal may be charged in the storage capacitor Cst. After the voltage corresponding to the data signal is charged in the storage capacitor Cst, the driving transistor DM may supply the current corresponding to the voltages charged in the threshold capacitor Cvth and the storage capacitor Cst to the OLED.

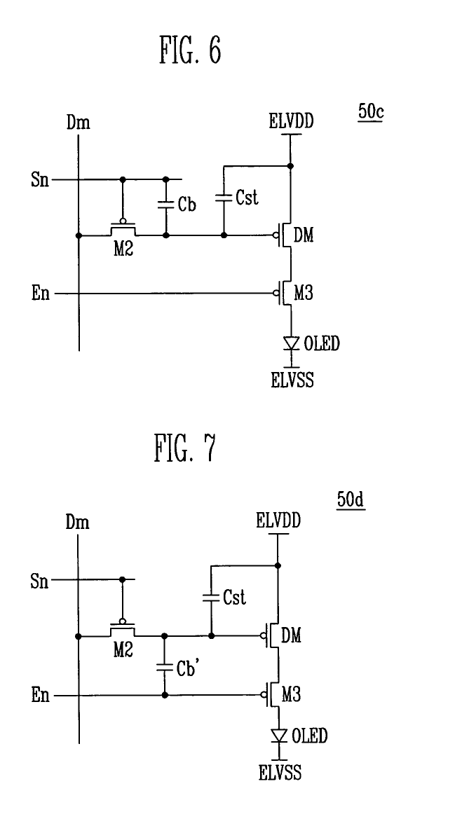

FIG. 6 illustrates a circuit diagram of another exemplary embodiment of a pixel 50c employable in the organic light emitting display of FIG. 1.

Referring to FIG. 6, the pixel 50c may include an organic light emitting diode OLED, a driving transistor DM to supply current to the OLED, a second transistor M2 coupled between the driving transistor DM and the data line Dm, a third transistor M3 coupled between the driving transistor DM and the OLED, a storage capacitor Cst to be charged with a voltage corresponding to a respective data signal, and a boosting capacitor Cb coupled between a gate electrode of the driving transistor DM and the scan line Sn.

The OLED may generate light with predetermined brightness based on a current supplied from the driving transistor DM. Actually, the OLED may generate light having one color among red, green, and blue based on the current supplied from the driving transistor DM.

The driving transistor DM may be coupled between the OLED and a first power source ELVDD. The driving transistor DM may control an amount of current that flows from the first power source ELVDD to a second power source ELVSS via the OLED based on the voltage of the gate electrode of the driving transistor.

A first electrode of the second transistor M2 may be coupled to the data line Dm and a second electrode of the second transistor M2 may be coupled to the gate electrode of the driving transistor DM. A gate electrode of the second transistor M2 may be coupled to the scan line Sn. The second transistor M2 may be turned on when a scan signal is supplied to the scan line Sn to supply the respective data signal from the data line Dm to the gate electrode of the driving transistor DM.

A first electrode of the third transistor M3 may be coupled to a second electrode of the driving transistor DM and a second electrode of the third transistor M3 may be coupled to the OLED. A gate electrode of the third transistor M3 may be coupled to the emission control line En. The third transistor M3 may be turned off when an emission control signal is supplied, e.g., has a low level, and is turned on in the other cases. The emission control signal may be supplied to overlap the scan signal.

The storage capacitor Cst may be coupled between the gate electrode of the driving transistor DM and the first power source ELVDD. The storage capacitor Cst may charge the voltage corresponding to the data signal.

The boosting capacitor Cb may be coupled between the scan line Sn and the gate electrode of the driving transistor DM. The boosting capacitor Cb may increase a voltage of the gate electrode of the driving transistor DM when the supply of the scan signal is stopped. More particularly, e.g., a voltage of the scan line Sn may be set to be low when the scan signal is supplied and may be set to be high when the supply of the scan signal is stopped. Therefore, when the supply of the scan signal is stopped, the voltage of the boosting capacitor Cb may be increased and the voltage of the gate electrode of the driving transistor DM may be increased by the boosting capacitor Cb.

The boosting capacitor Cb may compensate for the loss of the voltage of the data signal. That is, e.g., a voltage of the data signal may be effectively reduced to be lower than an intended voltage due to the IR drop. Thus, a voltage of the data signal supplied to the gate electrode of the driving transistor DM may not correspond to the intended voltage of the data signal. The boosting capacitor Cb may compensate for the loss of the voltage of the data signal.

Meanwhile, in embodiments, a capacitance of the boosting capacitor Cb may be set based on a position of the respective pixel 50c. For example, the further the respective pixel 50c is from the main power source line 30, a capacitance of the boosting capacitor Cb included in the respective pixel 50c may be smaller. That is, e.g., capacitances of the boosting capacitors Cb may be reduced from one end of the pixel unit 40 where the main power source line 30 is arranged toward a second end of the pixel unit 40 that is opposite to, e.g., faces, the one end.

As the capacitances of the boosting capacitors Cb decrease toward the second end, an amount of the increase in voltage of the gate electrode of the respective driving transistor DM may be reduced. In this case, an amount of the current supplied from the driving transistor DM may increase so that brightness may increase.

Therefore, in embodiments, the further the pixel 50c is from the main power source line 30, a capacitance of the respective boosting capacitor Cb may be smaller, such that the IR drop of the first power source ELVDD may be substantially and/or completely compensated. Embodiments may enable an image with improved and/or substantially/completely uniform brightness may be displayed regardless of the IR drop of the first power source ELVDD.

The driver 54 may be realized by various circuit configurations/elements that may drive the storage capacitor Cst and the threshold capacitor Cvth. For example, the driver 54 may include four transistors M2, M3, M4 and M5, as illustrated in FIG. 5. FIG. 5 illustrates a circuit diagram of an exemplary embodiment of the driver 54 of FIG. 4.

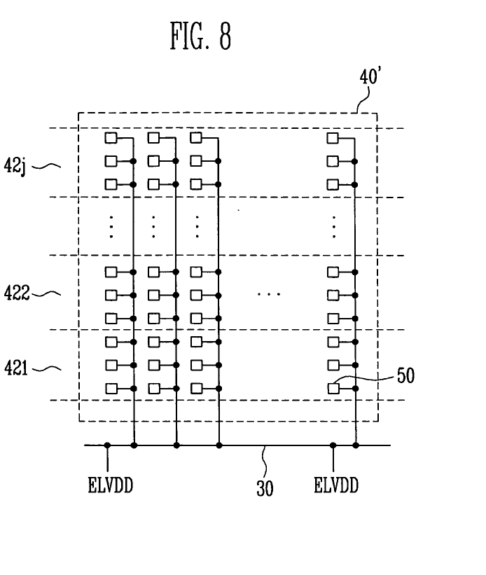

As discussed above, the pixel 50 of FIG. 1 may be realized by various circuit configurations/elements. For example, various embodiments of the pixel 50 may or may not include a boosting capacitor Cb. FIG. 7 illustrates a circuit diagram of another exemplary embodiment of a pixel 50d including a boosting capacitor Cb′ that is employable as the pixel 50 in the organic light emitting display of FIG. 1.

In embodiments, as illustrated in FIG. 7, the boosting capacitor Cb′ may be provided between a gate electrode of a driving transistor DM and an emission control line En. In such cases, the boosting capacitor Cb′ may reduce a voltage of the gate electrode of the driving transistor DM when a supply of the emission control signal is stopped.

In such embodiments, the further the pixel 50d is from the main power source line 30, a capacitance of the boosting capacitor Cb′ included in the pixel 50c may be higher. That is, the capacity of the boosting capacitor Cb′ increases from one end of the pixel unit 40 at which the main power source line 30 is formed toward a second end that is opposite to, e.g., faces, the one end.

As the capacitances of the boosting capacitors Cb′ increase from the one end to the second end, an amount of the reduction in the voltage at the gate electrode of the driving transistor DM may increase. In such cases, an amount of the current supplied from the driving transistor DM may increase and brightness may increase. Therefore, in embodiments, the further the pixel 50d is from the main power source line 30, the greater the capacitance of the boosting capacitor Cb′ may be, and the IR drop of the first power source ELVDD may be substantially and/or completely compensated. That is, in embodiments, an image with uniform brightness may be displayed regardless of the IR drop of the first power source ELVDD.

In the above description of exemplary embodiments, capacitances of the capacitors, e.g., Cst, Cvth, Cb, Cb′, are set to be sequentially increased or reduced in accordance with a position of the respective capacitor relative to the main power source line 30. Embodiments are not limited, however, to the above described exemplary embodiments.

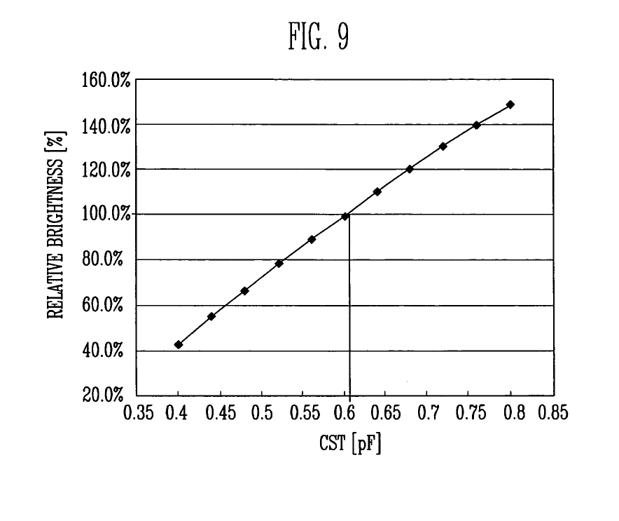

FIG. 8 illustrates a block diagram of another exemplary embodiment of an organic light emitting display.

Referring to FIG. 8, in embodiments, a pixel unit 40′ may be divided, e.g., into j (j is a natural number) blocks 421, 422 . . . 42j in horizontal units. Capacitances of capacitors, e.g., Cst, Cvth, Cb, Cb′, may be set to vary in units, e.g., one or two blocks, e.g., 421, 422, 42j. In such embodiments, capacitances of the capacitors, e.g., Cst, Cvth, Cb, Cb′, included in the pixels 50 of the same block may be the same, e.g., equal to each other.

More specifically, when, e.g., the pixel 50a of FIG. 2 is applied, the further the respective pixel 50a is from the main power source line 30, the greater the capacitance of the storage capacitor Cst may be in units of the blocks, e.g., 421, 422, 42j. In this case, the IR drop of the first power source ELVDD may be substantially and/or completely compensated so that an image with improved and/or substantially/completely uniform brightness may be displayed. When the capacitances of the storage capacitors Cst are set in units of the blocks, e.g., 421, 422, 42j, errors, e.g. processing errors may be minimized.

When, e.g., the pixel 50b of FIG. 4 is applied, the further the pixel 50b is from the main power source line 30, the greater the capacitance of the threshold capacitor Cvth may be in units of the blocks, e.g., 421, 422, 42j. In such cases, the IR drop of the first power source ELVDD may be substantially and/or completely compensated so that an image with substantially and/or completely uniform brightness may be displayed. When the capacitances of the storage capacitors Cst are set in units of the blocks, e.g., 421, 422, 42j, errors, e.g. processing errors, may be minimized.

When, e.g., the pixel 50c of FIG. 6 is applied, the further the pixel 50c is from the main power source line 30, the smaller the capacitance of the boosting capacitor Cb may be in units of the blocks, e.g., 421, 422, 42j. In such cases, the IR drop of the first power source ELVDD may be substantially and/or completely compensated so that an image with substantially and/or completely uniform brightness may be displayed. When the capacitances of the boosting capacitors Cb are set in units of the blocks, e.g., 421, 422, 42j, errors, e.g., processing errors, may be minimized.

When, e.g., the pixel 50d of FIG. 7 is applied, the further the pixel 50d is from the main power source line 30, the greater the capacitance of the boosting capacitor Cb′ may be in units of the blocks, e.g., 421, 422, 42j. In such cases, the IR drop of the first power source ELVDD may be substantially and/or completely compensated so that an image with substantially and/or completely uniform brightness may be displayed. When the capacitances of the storage capacitors Cb′ are set in units of the blocks, e.g., 421, 422, 42j, errors, e.g., processing errors, may be minimized.

FIG. 9 illustrates a simulation result graph of a relationship between capacitance and brightness of a pixel including a storage capacitor CST.

Referring to FIG. 9, it is noted that brightness of a pixel increases when the capacity of the storage capacitor CST increases and that the brightness of the pixel is reduced when the capacity of the storage capacitor CST is reduced. As a result, in embodiments, the IR drop of the first power source ELVDD may be substantially and/or completely compensated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display, comprising:
scan lines and data lines that overlap each other;
a pixel unit including pixels positioned at intersections of the scan lines and the data lines;
a main power source line at one end of the pixel unit and adapted to receive a voltage of a first power source; and
sub power source lines coupled to the main power source line and the pixels,
wherein each of the pixels comprises at least one capacitor, and
wherein the capacitors have different capacitances based on a position of the respective pixels relative to the main power source line.

2. The organic light emitting display as claimed in claim 1, wherein the capacitances of the capacitors vary in groups of one or more rows of pixels, the rows of the pixels extending along a direction parallel to a direction along which the main power source line extends.

3. The organic light emitting display as claimed in claim 2, wherein the capacitances of the capacitors vary in groups of one or two rows of pixels, the rows of the pixels extending along a direction parallel to a direction along which the main power source line extends.

4. The organic light emitting display as claimed in claim 1, wherein each of the pixels comprises:
an organic light emitting diode;
a driving transistor adapted to control an amount of current that flows from the first power source to a second power source via the organic light emitting diode;
a storage capacitor coupled between a gate electrode of the driving transistor and the first power source; and
a driver coupled to the respective data line and the respective scan line to supply a data signal supplied from the respective data line to the storage capacitor based on a scan signal supplied to the respective scan line.

5. The organic light emitting display as claimed in claim 4, wherein the further the respective pixel is from the main power source line, the greater the capacitance of the storage capacitor of the respective pixel is.

6. The organic light emitting display as claimed in claim 1, wherein each of the pixels comprises:
an organic light emitting diode;
a driving transistor adapted to control an amount of current that flows from the first power source to a second power source via the organic light emitting diode;
a threshold capacitor and a storage capacitor serially coupled between a gate electrode of the driving transistor and the first power source; and
a driver coupled to the respective data line and the respective scan lines to supply a data signal supplied from the respective data line to the storage capacitor based on a scan signal supplied to the respective scan line.

7. The organic light emitting display as claimed in claim 6, wherein the further the respective pixel is from the main power source line, the greater the capacitance of the storage capacitor of the respective pixel.

8. The organic light emitting display as claimed in claim 1, wherein each of the pixels comprises:
an organic light emitting diode;
a driving transistor adapted to control an amount of current that flows from the first power source to a second power source via the organic light emitting diode;
a storage capacitor coupled between a gate electrode of the driving transistor and the first power source;
a second transistor coupled between the respective data line and the gate electrode of the driving transistor to be controlled by a scan signal supplied to the respective scan line;
a third transistor coupled between the driving transistor and the organic light emitting diode and adapted to be controlled by an emission control signal supplied from an emission control line extending parallel with the scan lines; and
a boosting capacitor coupled between the gate electrode of the driving transistor and one of the respective scan line or the respective emission control line.

9. The organic light emitting display as claimed in claim 8, wherein the boosting capacitor is coupled between the gate electrode of the driving transistor and the respective scan line and the further the respective pixel is from the main power source line, the smaller the capacitance of the boosting capacitor of the respective pixel is.

10. The organic light emitting display as claimed in claim 8, wherein the boosting capacitor is coupled between the gate electrode of the driving transistor and the respective emission control line and the further the respective pixel is from the main power source line, the greater the capacitance of the boosting capacitor of the respective pixel.

11. The organic light emitting display as claimed in claim 1, wherein the sub power source lines extend parallel to the data lines.

12. The organic light emitting display as claimed in claim 1, further comprising a second main power source line arranged an another end of the pixel unit to receive the voltage of the first power source, wherein the capacitors have different capacitances based on a position of the respective pixels relative to the main power source line or the second main power source line to which it is connected.

13. An organic light emitting display, comprising:
scan lines and data lines that overlap each other;
a pixel unit including pixels positioned at intersections of the scan lines and the data lines and each having at least one capacitor;
a main power source line arranged at one end of the pixel unit to receive a voltage of a first power source; and
sub power source lines extending from the main power source line and coupled to the pixels in units of vertical lines,
wherein the pixel unit is divided into a plurality of blocks each including at least two rows of the pixels, and
wherein the capacitors of the pixels of each of the blocks have different capacitances based on a position of the respective block with which the respective pixel is associated with relative to the main power source line.

14. The organic light emitting display as claimed in claim 13, wherein each of the pixels comprises:
an organic light emitting diode;
a driving transistor adapted to control an amount of current that flows from the first power source to a second power source via the organic light emitting diode;
a storage capacitor coupled between a gate electrode of the driving transistor and the first power source; and
a driver coupled to the respective data line and the respective scan line to supply a data signal supplied from the respective data line to the storage capacitor based on a scan signal supplied to the respective scan line.

15. The organic light emitting display as claimed in claim 13, wherein the further the respective bock is from the main power source line, the greater the capacitance of the storage capacitors of the respective block is.

16. The organic light emitting display as claimed in claim 13, wherein each of the pixels comprises:
an organic light emitting diode;
a driving transistor adapted to control an amount of current that flows from the first power source to a second power source via the organic light emitting diode;
a threshold capacitor and a storage capacitor serially coupled between a gate electrode of the driving transistor and the first power source; and
a driver coupled to the respective data line and the respective scan line to supply a data signal supplied from the respective data line to the storage capacitor to correspond to a scan signal supplied to the respective scan line.

17. The organic light emitting display as claimed in claim 13, wherein each of the pixels comprises:
an organic light emitting diode;
a driving transistor to control an amount of current that flows from the first power source to a second power source via the organic light emitting diode;
a storage capacitor coupled between a gate electrode of the driving transistor and the first power source;
a second transistor coupled between the data lines and the gate electrode of the driving transistor to be controlled by a scan signal supplied to the scan lines;
a third transistor coupled between the driving transistor and the organic light emitting diode and adapted to be controlled by an emission control signal supplied from an emission control line formed parallel with the scan lines; and
a boosting capacitor coupled between the gate electrode of the driving transistor and the respective scan line or the respective emission control line.

18. The organic light emitting display as claimed in claim 17, wherein the boosting capacitor of each of the pixels is coupled between the gate electrode of the driving transistor and the respective scan line and the further the respective bock is from the main power source line, the less the capacitance of the boosting capacitors of the respective block.

19. The organic light emitting display as claimed in claim 17, wherein the boosting capacitor of each of the pixels is coupled between the gate electrode of the driving transistor and the respective emission control line and the further the respective bock is from the main power source line, the greater the capacitance of the boosting capacitors of the respective block.

20. An organic light emitting display, comprising:
scan lines and data lines that overlap each other;
a pixel unit including pixels positioned at intersections of the scan lines and the data lines and each having at least one capacitor;
a main power source line arranged at one end of the pixel unit to receive a voltage of a first power source; and
sub power source lines extending from the main power source line and coupled to the pixels in units of vertical lines,
wherein the pixel unit is divided into a plurality of blocks each including at least two rows of the pixels, and
main power source voltage compensating means for compensating for an voltage drop of the voltage of the first power source supplied to each of the pixels via the subs power source lines.
